(19) United States
(12) Patent Application Publication
(10) Pub. No.: US 2026/0184939 A1
(43) Pub. Date: Jul. 2, 2026

(54) AUXETIC MATERIAL BASED ANTI-FOULING COMPOSITE

(71) Applicant: The Governors of the University of Alberta, Edmonton (CA)

(72) Inventors: Hyun-Joong Chung, Edmonton (CA); David Liu, Edmonton (CA)

(73) Assignee: The Governors of the University of Alberta, Edmonton (CA)

(21) Appl. No.: 19/432,269

(22) Filed: Dec. 24, 2025

Related U.S. Application Data
(60) Provisional application No. 63/739,722, filed on Dec. 30, 2024.

(51) Int. Cl. C09D 5/16; B05D 3/10; B29C 39/02; B29K 83/00; C09D 7/62; C09D 183/06; C09K 3/18

(52) U.S. Cl. CPC C09D 5/1675; B05D 3/108; B29C 39/026; C09D 7/62; C09D 183/06; C09K 3/18; B29K 2083/00

(57) ABSTRACT

An anti-fouling shield composite material for shielding and removing ice or slush from a surface and a method of forming the same. The composite material including a cured organogel matrix and an auxetic skeletal structure, wherein the composite material has a negative Poisson's ratio that results in an increase in net surface area of the shield to shed ice from a surface of the shield when stretched. The method including mixing a silicone and a silicone oil to form an uncured organogel matrix; separately mixing fumed silica and a silicone precursor to form a second uncured material; curing the second uncured material to form the cured auxetic skeletal structure and molding that into a shape of the anti-fouling shield; pouring the uncured organogel matrix around and covering the cured auxetic skeletal structure; and curing the uncured organogel matrix to form the anti-fouling shield composite material.

### RELATED APPLICATIONS

This application claims priority benefit of U.S. Provisional Application Ser. No. 63/739,722, filed Dec. 30, 2024, the contents of which are hereby incorporated by reference.

### FIELD OF THE INVENTION

The present invention relates to a composite material for shielding and removing ice or ice/clay slush from a surface, and more particularly, to a composite material having an auxetic structure within a matrix and a negative Poisson's ratio that results in an increase in net surface area of the composite material to shed ice from a surface thereof when stretched.

### BACKGROUND OF THE INVENTION

Autonomous vehicles are a growing industry, with growing development for personal use and industry. These vehicles rely on their various sensors which include cameras, light detection and ranging (LiDAR), and radar. These sensors provide perception which leads to planning controls of the vehicles [1, 2]. The camera sensor records light entering the lens to record an image, while lidar emits a laser and the reflection from this is used to generate a map. It is important for the lenses of these sensors to be clear and free from debris, or else there may be issues with the data collected. In colder climates, ice and slush formation on these sensors is a significant concern given that if these sensors are blocked by the buildup of ice and slush the sensors are obstructed and unable to provide critical information for detecting obstacles.

Current anti-icing surfaces and technologies such as superhydrophobic surfaces and sprays have limitations due to wear and reusability. Current technologies used to de-ice can be split into two categories, solid and liquid anti-icing.

Solid anti-icing technology includes nanoarchitecture structures that are based on the lotus leaf, as well as low surface energy coatings such as PTFE coatings on pans. The nanoarchitecture surface effectiveness can be explained by the Cassie-Baxter model, where in a droplet on a rough surface is not fully wetted due to air trapped underneath the liquid and acts as a barrier, reducing the total surface area for the droplet on the substrate [4]. This increases the contact area with air, therefore increasing the contact angle of the water when compared to a smooth surface [5]. For low surface energy coatings, the material surface has a lower energy which causes the water to be attracted to itself rather than the surface [6]. However, when these surfaces wear, they are difficult to fix and can become more hydrophilic [7].

For anti-icing liquids, these include various solutions such as propylene or ethylene glycol for plane de-icing or brine and salt solutions [8, 9]. Propylene glycol is a commonly used deicer, which lowers the freezing point of water. It is sprayed on at high temperature to remove existing ice. Salt and brine solutions work in a similar matter. These solutions are temporary and must be reapplied consistently. Current plane deicers only last around 30-80 minutes depending on the type. In addition, there are other concerns depending on the deicer used, as salt solutions can be corrosive and are not used on planes significant effect on vehicles when used on roads [8].

A new idea is to combine both of these technologies. Slippery liquid-infused porous surfaces (SLIPS) combine both technologies [10]. They are based on the idea of the nepenthes pitcher plant where there is a porous polymer matrix that stores and secretes a lubricating layer. This acts as a barrier which prevents the formation and buildup of ice, allowing for multiple uses. One common SLIPS system is an organogel. An organogel consists of an external non-polar solvent phase that is immobilized between the open spaces of a 3d network structure [11]. When silicone oil or other water repelling fluids are used, it can form an anti-icing layer on the surface of the gel. These organogel slips systems have been shown to have effective anti-icing capabilities. Common organogel systems include PDMS with silicone oil, as they have been shown to be clear and transparent, as silicone oil and PDMS have similar refractive index.

Previous research has shown the effectiveness of using reinforcing structures in softer materials such as the double network [12-14]. In addition, it was shown that the embedded structure can provide other effects such as a negative Poisson's ratio [15]. Auxetics are materials that possess a negative Poisson's ratio, where a material will expand outwards when stretched or contract inwards when compressed [16-19].

Thus, there exists a need for an anti-icing material that prevents and removes ice on a surface, that is suitable for use on vehicle sensors, that exhibits auxetic anti-icing of a surface, and that does not exhibit the wear and reapplication problems of exiting de-icing compositions.

### SUMMARY OF THE INVENTION

The present invention provides an anti-fouling shield composite material for shielding and removing ice or ice/clay slush from a surface. The anti-fouling shield composite material including a cured organogel matrix and an auxetic skeletal structure, wherein the composite material has a negative Poisson's ratio that results in an increase in net surface area of the shield to shed ice from a surface of the shield when stretched.

A method of forming such an anti-fouling shield composite material is also provided, which includes mixing a silicone and a silicone oil to form an uncured organogel matrix; separately mixing fumed silica and a silicone precursor to form a second uncured material; shaping an auxetic skeletal structure using the second uncured material; curing the second uncured material of the shaped auxetic skeletal structure to form the cured auxetic skeletal structure; placing the cured auxetic skeletal structure in a mold having a shape of the anti-fouling shield; pouring the uncured organogel matrix into the mold having the shape of the anti-fouling shield around and covering the cured auxetic skeletal structure; and curing the uncured organogel matrix to form the anti-fouling shield composite material.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram showing a process for fabricating and testing of the organogel matrix, the auxetic structure, and the organogel composite according to embodiments of the present invention;

FIG. 2A shows a cured organogel matrix according to embodiments of the present invention;

FIG. 2B shows the auxetic structure of the organogel composite according to embodiments of the present invention;

FIG. 2C shows the organogel composite according to embodiments of the present invention;

FIG. 3 shows the oil release experiment used to test embodiments of the present invention;

FIG. 4 shows the test setup for static ice adhesion testing including a linear stage and a force gauge to testing embodiments of the present invention;

FIG. 5 shows the setup for the stretching ice adhesion test developed to test the effectiveness of the organogel composite embodiments of the present invention;

FIG. 6 is a graph showing oil release testing results;

FIG. 7 shows a graph of UV vis spectroscopy results;

FIG. 8A is a graph showing tensile testing results for the organogel matrixes and silicone;

FIG. 8B is a graph showing Young's modulus for the samples, where the organogels have significantly lower Young's modulus values than that of the comparable silicones;

FIG. 8C is a graph showing tensile testing results for fumed silica filled Sylgard 184;

FIG. 8D is a graph showing values of Young's modulus for the fumed silica filled Sylgard 184, pure Sylgard 184, and S184O1;

FIGS. 9A and 9B show Poisson's testing results;

FIG. 10 shows ice adhesion testing values;

FIG. 11A shows the stretching test of the Sylgard 184 Sample;

FIG. 11B shows the stretching test of the S184O2 Auxetic Sample;

FIG. 11C shows results of the cyclic ice adhesion testing after applying fifty strain cycles for each test;

FIGS. 12A-12D show the stretching test of various samples with ice slush placed thereon;

FIG. 12E shows the ice slush adhesion testing results;

FIG. 13A shows an organogel composite according to embodiments of the present invention; and

FIG. 13B shows a plain organogel sample without any auxetic structure therein.

### DESCRIPTION OF THE INVENTION

The present invention has utility as an anti-fouling material that prevents and removes ice or ice/clay slush on a surface, that is suitable for use on vehicle sensors, that exhibits auxetic anti-icing of a surface, and that does not exhibit the wear and reapplication problems of exiting de-icing compositions. Still other applications that benefit from the present invention illustratively include vehicle sensor clearance, other surfaces that require anti-fouling surfaces include planes, ships, and marine blades. While the present invention will hereafter be detailed with respect to removing ice, it is appreciated that defouled substances also include caked mud, or an ice-clay slush.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

The terminology used herein is for the purpose of describing particular example embodiments only and is not intended to be limiting. Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. Unless indicated otherwise, explicitly or by context, the following terms are used herein as set forth below.

As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The present invention provides an organogel-based composite embedded with an auxetic skeletal structure to serve as a transparent protective anti-fouling shield on optical sensors, particularly for autonomous vehicle sensors. When stretched, the negative Poisson's ratio of the de-icing composite results in an increase in the net surface area of the shield while the deposited ice cannot expand, resulting in shedding the ice from the structure on which the de-icing shield is applied.

As used herein, the Poisson's ratio is defined in 2-dimensions (2D), and not 3-dimensions (3D) as the focus in this invention is the change in area on the surface of the organogel composite, not including the thickness variation of the sample.

According to certain inventive embodiments, the organogel matrix is made by combining silicone elastomer precursor with silicone oil and further is further enhanced with a stiff, elastomeric re-entrant honeycomb structure created from fumed silica filled, such as Sylgard 184 so as to create an oily lubricating surface. Image analysis reveals a notable Poisson's ratio of −0.52 in 2D for composites with the silicone rubber organogel matrix of the present invention, compared to a typical value of 0.5 for regular organogels.

According to certain inventive embodiments, the anti-fouling organogel composite includes at least two different parts: the organogel matrix and the auxetic structure. The organogel matrix provides a stretchy, anti-fouling surface used to shed any ice buildup that affords a lubricated oil surface while the auxetic structure is used to create an areal mismatch between the organogel and the ice, helping shed the ice while reinforcing the organogel as well.

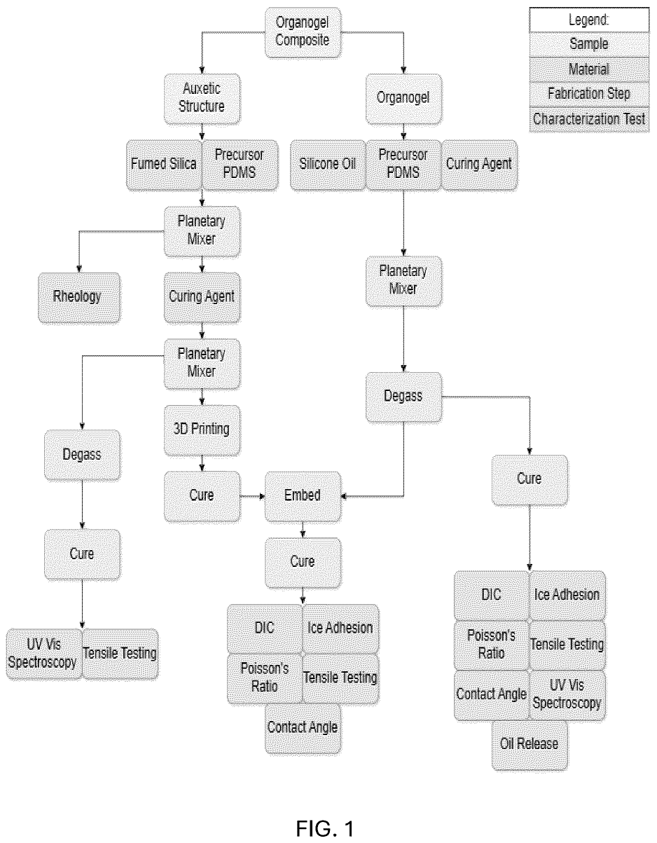

To properly evaluate the capabilities of the organogel composite, characterization tests are performed on the organogel, the auxetic structure, the whole composite in order to determine the effectiveness of the individual parts as well as the totality of the components. In order to quantify the ice adhesion on the shield, home-built testing equipment is devised to quantify the anti-fouling capabilities of the organogel-based composites, as well as the effectiveness of the auxetic structures in shedding ice. The organogels had the lowest ice adhesion values when compared to steel, glass, acrylic, and PTFE. In ice shedding experiments with repeating strain cycles, the organogel-based composites were the most effective in removing the ice. In summary, the organogel-based composites of the present invention possess a negative Poisson's ratio, and the auxetic property is proven herein to provide an excellent anti-fouling property. The results suggest that the organogel based composite of the present invention has utility as a shield for a variety of purposes, ranging from camera sensor shields for autonomous vehicles, anti-icing plane wings, anti-biofouling marine ship hulls and more. FIG. 1 shows the process for fabricating and testing of the organogel matrix, the auxetic structure, and the organogel composite.

The materials used for the following discussion include Silicones: Sylgard 184 from Dow Chemical's [20], Solaris and Ecoflex 00-30 from Smooth-on [21, 22], Silicone oil: 100 cSt oil from Sigma Aldrich [23], and Filler: Fumed silica from Sigma Aldrich [24]; however, the present disclosure is not limited to these materials and it will be understood that other similar materials are likewise suitable for the present invention.

For both the organogel matrix, auxetic structure, and the organogel composite, they are all made with the use of a planetary mixer. The organogel matrix is made in a one pot synthesis, with the silicone, curing agent, and silicone oil added at once before being mixed. Afterwards, it is poured into the desired mold and degassed before curing in an oven for 80° C. The mixing ratios for the silicones and organogels can be seen in Table 1 below.

TABLE 1
Sample Mixing Ratios and Curing Time or organogels

| | | Silicone to | | |
|---|---|---|---|---|
| Sample | Silicone | Oil Ratio | Cure Time | |
| S184O1 | Sylgard 184 | 1:1 | 1 | Hour |
| S184O2 | Sylgard 184 | 1:2 | 1 | Hour |
| S184O3 | Sylgard 184 | 1:3 | 4 | Hours |
| SOLO1 | Solaris | 1:1 | 1 | Hour |
| E30O1 | Ecoflex 00-30 | 1:1 | 4 | Hours |
| HO1 | Blend* | 1:1 | 1 | Hour |

Testing done on the organogel include tensile testing, Ultraviolet visible spectroscopy, oil release, ice adhesion testing, and Poisson's ratio testing.

The auxetic structure is made in a similar manner. Fumed silica and 1 to 1 mix ratio dielectric gel precursor solution are mixed with the planetary mixer. Once fully mixed, the mixture is allowed to cool before curing agent is added and the solution is mixed again. It is added after the first mixing step to prevent any premature curing of the silicone due to the high temperatures of the solution while mixing for long periods of time. After mixing, the mixture is poured into molds or transferred to a syringe for 3D printing of the auxetic structure. Once in the mold or printed, the fumed silica filled dielectric gel is cured at 80 C for 2 hours. Tests performed on the fumed silica filled dielectric gel include UV vis spectroscopy and tensile testing. To make the organogel composite, fumed silica filled dielectric gel was 3D printed into the desired pattern and cured at 80 C with an Allevi bioprinter [25]. Afterwards, it would be placed in another mold and the organogel matrix solution would be poured over top, with enough to fully cover the structure. Then it would undergo one more cure step.

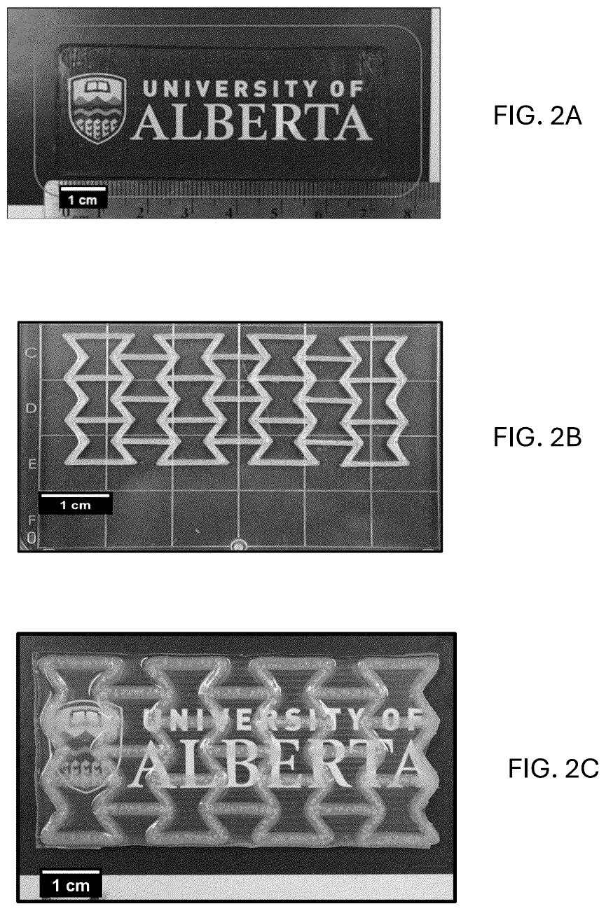

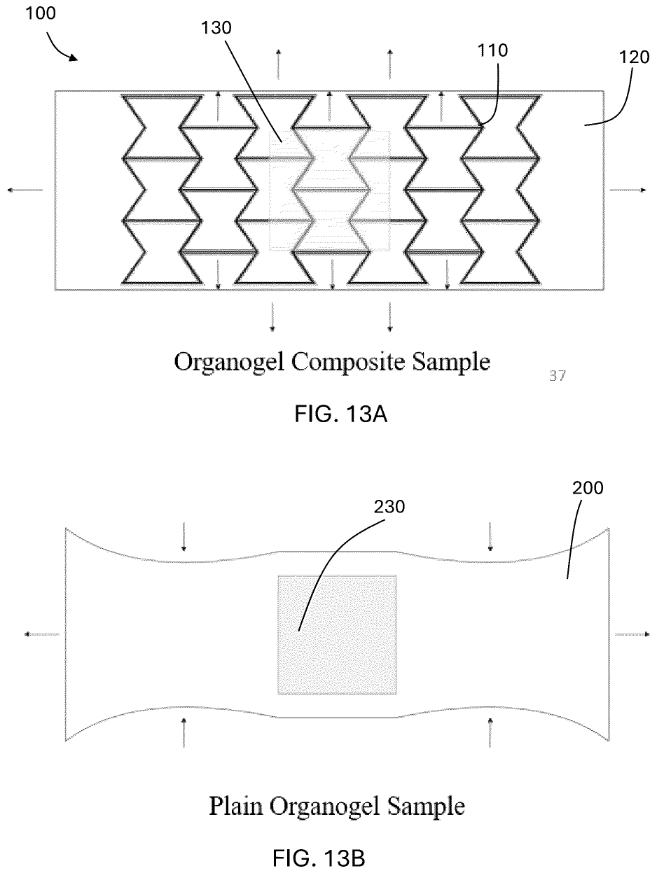

FIG. 2A shows a cured S184O1 organogel matrix. Note the clarity and the oily surface thereof. FIG. 2B shows the auxetic structure of the organogel composite, printed with from 0 to 50 wt. % fumed silica filled dielectric gel. FIG. 2C shows the organogel composite made with S18402 organogel matrix. Notably, the organogel matrix is transparent while the auxetic structure is translucent. FIG. 13A shows an organogel composite 100 according to embodiments of the present invention with the auxetic structure 110 positioned within the organogel matrix 120 and with ice 130 placed thereon. Notably, when the composite 100 is stretched at its ends, the expansion of the auxetic structure 110 inside the organogel composite 100 creates an areal mismatch that sheds the ice 130 from the surface of the composite 100. FIG. 13B shows a plain organogel sample 200 without any auxetic structure therein. Notably, when stretched from its ends the non-composite sample 200 stretches in the areas where ice 230 is not in contact due to the elastic behavior of the composite sample 200 and the ice is not removed.

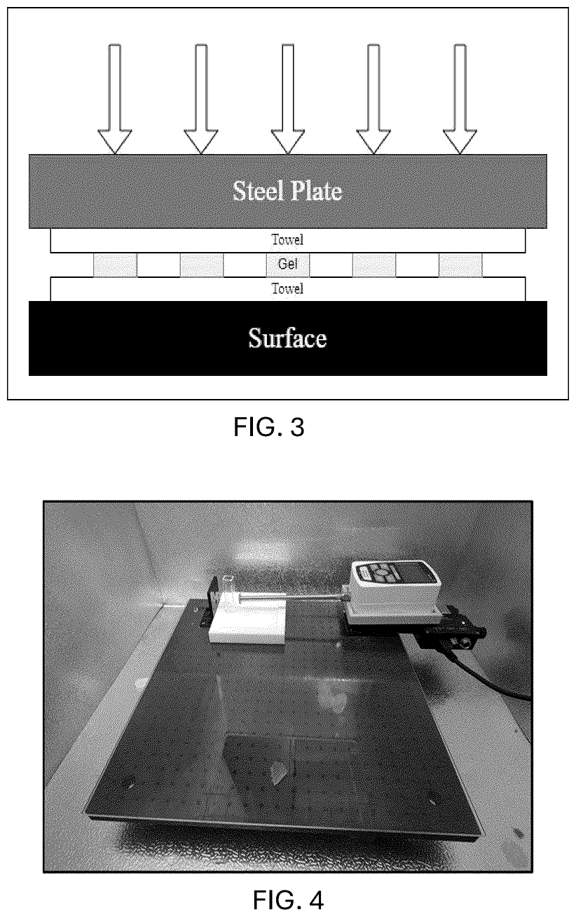

A test was devised to measure the storage capacity and lubricating ability of the organogels. The organogel test candidates were cut into 1 cm squares with a thickness of 3 mm after curing. These squares were weighed directly after curing and cutting to show the maximum weight. The samples were left over night to self-lubricate. Samples were wiped down and reweighed again after this period of time. Then, the samples had a large steel plate put on top of the samples to squeeze oil from the organogels. The top and bottom were covered with towels to absorb any lubricant that was squeezed out. The plate was left on top of the organogels for a full day. Afterwards, the samples were wiped down again and weighed to determine the change in weight. This was done for a few days or until there was no noticeable difference in weight. FIG. 3 shows the oil release experiment with a steel plate applying pressure on to the organogels and towels used to absorb any oil that is secreted and are replaced every 24 hours.

Tensile testing was done with an Instron machine and following ASTM standard D412 for rubbers and elastomers [26, 27]. Samples were prepared in a dog bone shaped mold recommended by ASTM D412. The guidelines state that the tension test must be done at a uniform rate of 500±50 mm/min for a distance of at least 750 mm. Abrasive tape was added to the clamps due to the slippery nature of the organogels. Samples tested include the base silicones, the organogels, and fumed silica fumed dielectric gel.

To determine the effects of the auxetic structure embedded in the organogel composite, the measurement of the Poisson's ratio was required. This was done with the use of a Cellscale Univert tester with samples with a gauge length of 50 mm and 35 mm wide [28]. The definition of Poisson's ratio is the ratio of transverse strain over the longitudinal strain in a material that is being deformed in 1 axis. For this experiment, the Poisson's ratio is defined in 2d, not 3d as the focus in this experiment is the change in area on the surface of the organogel composite, not including the thickness of the sample. Before clamping, the samples were marked with paint for camera tracking purposes. Samples were stretched for 10 mm for 5 s (2 mm/s), with photos being taken every second. A Sony ILCE-6400 camera with the SEL 30 mm macro lens were used to take photos of the sample.

Ultraviolet visible spectroscopy (UV/Vis) was used to measure the absorption of light for the created gels. This was done to measure optical transparency of the gels in the visible light range, determining if the gels would be suitable for optical applications. A Hitachi U-3900H spectrophotometer was used to measure the transmittance from 240-800 nm wavelength of light, manufactured by Hitachi, Japan [29]. The varying samples were cut into thin strips around 1 cm in width and placed into cuvettes for testing. Scan speed was set to 300 nm/min at a sampling interval of 0.5 nm.

Ice adhesion testing can take many different forms. There are two categories used to describe ice adhesion testing, static and impact. Static ice consists of freezing water in a cuvette on top of a substrate and measuring the force required to remove the cuvette. The design of the experiment consists of a force gauge attached to a linear stage. This is placed inside of a freezer to freeze the ice in the cuvette at a constant temperature. Samples were frozen for a period of 15 hours. The linear stage was operated at a speed of 1 mm/s when being actuated towards the sample, with the force required to shear the ice being recorded. This setup is shown in FIG. 4 with static ice adhesion testing including a linear stage and a force gauge.

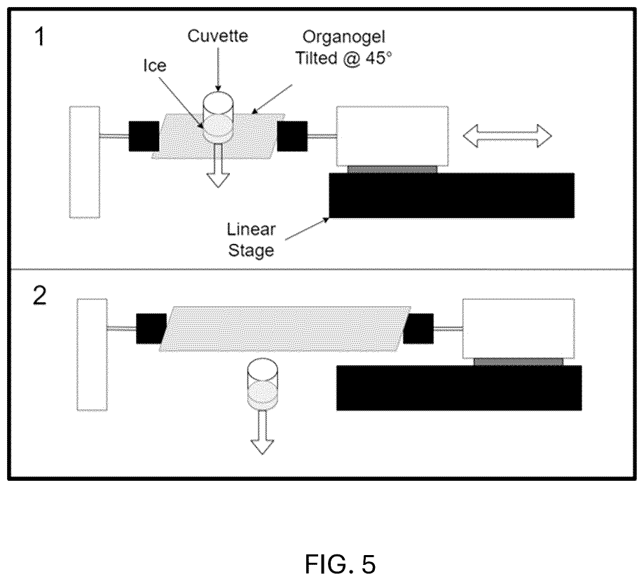

Another ice adhesion test was designed to determine the benefits of stretching the organogel composites. The organogel sample was clamped on both ends, with one end fixed and the other attached to the linear scale. Water was frozen inside of a cuvette placed on top of the surface. Once frozen, the sample was tilted 45 and subjected to 50 strain cycles, 10 mm in displacement. The amount of cycles required to shed the ice was recorded. The setup for this stretching ice adhesion test developed to test the effectiveness of the organogel composite is shown in FIG. 5.

### Results and Discussion:

### Oil Release

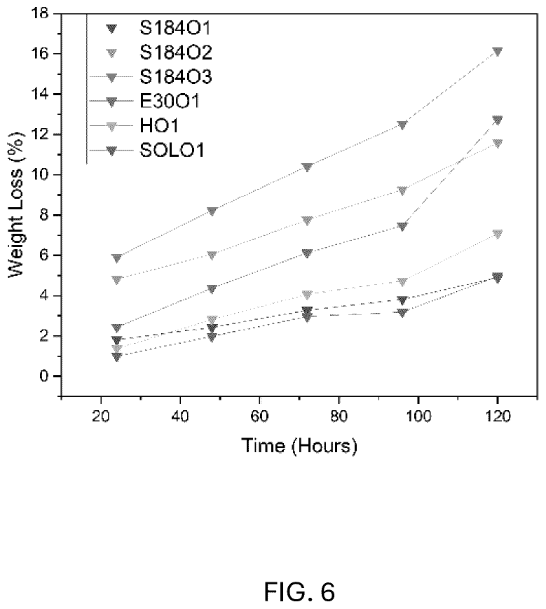

Every test sample left behind an oily residue on the paper towel, showing some form of oil had been secreted from the gels. This was further evidenced as all of the tested samples showed weight loss after testing. The S184O3 sample had the largest amount of weight loss, followed by E30O1 and S184O2. These results indicate that dielectric gel and silicone rubber are the best candidates for the organogel due to the amount of oil weight loss. In addition, the amount of oil added appears to have a significant effect on the amount of oil released. The SOLO1, S184O1, and HO1 sample showed minimal weight change when compared to the other samples, however it was evident from the paper towel that there was some oil release. The S184O1 sample was surprising, as it had formed a clear layer of oil on the surface prior to the oil release testing. This is in part due to the sample having a lower total oil reservoir amount when compared to S184O2 and S184O3. From this result, it shows that in order to get a lubricating layer, larger amounts of silicone oil added will result in a more consistent oil release as well as more oil storage in the polymer matrix and that specific silicones can release oil easier. Based on these results, S184O2, S184O3, and E30O1 are the best candidates for the organogel structure. FIG. 6 is a graph showing oil release results. The S184O3, E30O1, and S184O2 samples show the most oil release overtime. All samples lost weight, indicating the release of oil.

### UV Vis Results

To function as a shield for autonomous vehicles, the clear shield must be clear or transparent to allow the sensors to detect light. To test the gel and the auxetic structures transparency, Ultraviolet visible spectroscopy was done to determine the gels transmittance values. The different silicone candidates, organogel mixtures, and fumed silica were tested.

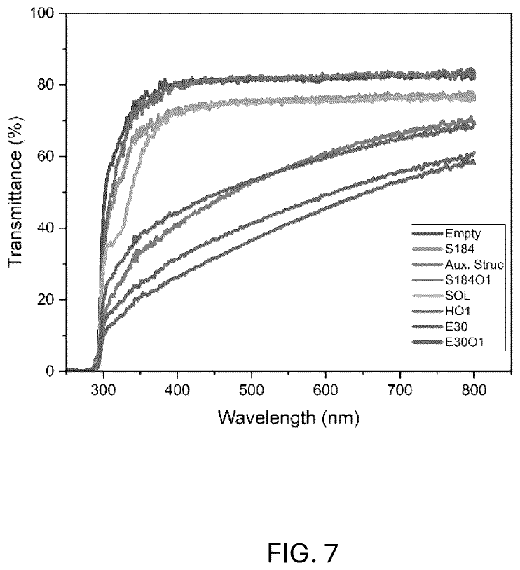

Testing was done from a range of 200 nm to 1000 nm, covering the visible spectrum as well as some of the ultraviolet and infrared wavelengths. The empty cuvette functions as a control sample where it is assumed that it is perfectly clear. 1 to 1 mix ratio dielectric gel, Solaris, and the accompanying samples that were mixed with silicone oil also showed comparable transmittance to the empty cuvette, indicating that they had great clarity in the visible light regions. The addition of silicone oil to dielectric gel did not have a negative effect on the transmittance, indicating a good match between the 3D polymer matrix and lubricant. Fumed silica and the hybrid mixture had the next best clarity as both transmittance values were found to be comparable to each other and would best be described as transparent. The hybrid sample consisted of one quarter part silicone rubber, which was the most likely reason for the decrease in transmittance despite the other 3 quarters consisting of dielectric gel and silicone oil. There are no known molecular regions that can cause a drastic absorption to change for the LiDAR regime, and the UV-Vis results gives a good estimation on the optical transparency for LiDAR. Ecoflex 00-30 and E30O1 were found to be the least clear samples and would not meet the transparency criteria. Their tested values were roughly the same despite E30O1 diluting the amount of silicone rubber in the sample, dielectric gel and Solaris are the best candidates for a camera sensor due to their excellent transparency. The fumed silica is translucent in comparison and would result in a grid like viewing pattern if used. FIG. 7 shows a graph of UV vis spectroscopy results. The dielectric gel, S184O1, and Solaris show the best clarity, comparable to the empty cuvette. The fumed silica mixture is considered translucent. Ecoflex and E30O1 show the worst clarity of the samples tested.

### Tensile Testing

Tension testing was performed to determine the effect of silicone oil and fumed silica to silicones. This was performed using an Instron tension tester, following ASTM D412 standards for rubbers and thermoplastics. All samples were prepared in PTFE molds in a dog bone shape recommended by ASTM D412. The difference between the base silicones was notable, with dielectric gel being the stiffest silicone, while silicone rubber showed great stretching capability. The addition of silicone oil to silicone had a significant reduction on the elastic modulus values. Every sample organogel had a lower elastic modulus than the standard silicone. This is likely due to a reduction in the crosslink density, with the silicone oil diluting the silicone. It should also be noted that the addition of silicone oil did not increase the durability of the gel, with the fracture strains being around the same for almost all of the samples. The exception to this was E1, as its maximum strain value was almost twice as much as base silicone rubber.

When fumed silica was added to dielectric gel, there was a noticeable increase in the elastic modulus. The values of elastic modulus were 3-4 times higher for fumed silica filled dielectric gel. Similar to the silicone oil, it also did not greatly affect the strains either as only 11 wt. % showed significantly higher strains. In addition, there appeared to be a linear relationship between Young's modulus and wt. % fumed silica, potentially making it possible to predict the Young's modulus with increasing fumed silica. This appears to be in line with a modified Halpin-Tsai model for spherical nanoparticles, which also shows a relatively linear curve when comparing elastic modulus and wt. % nanoparticles. In addition, there have been previous studies that have tested the relationship of fumed silica mixed with PDMS, showing similar linearity (Source).

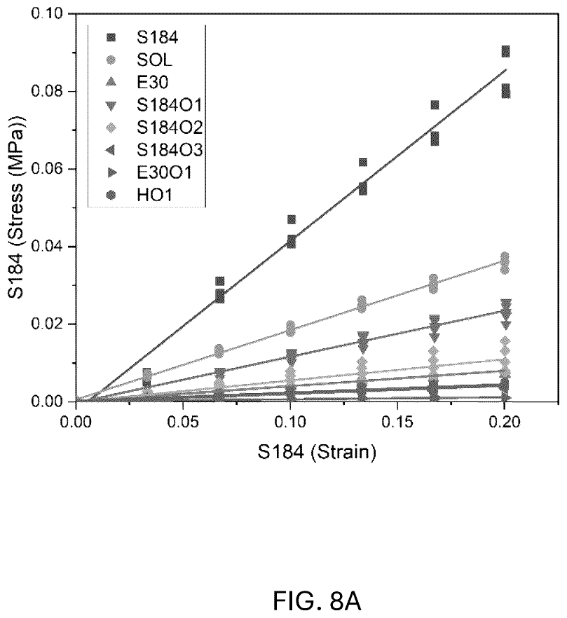

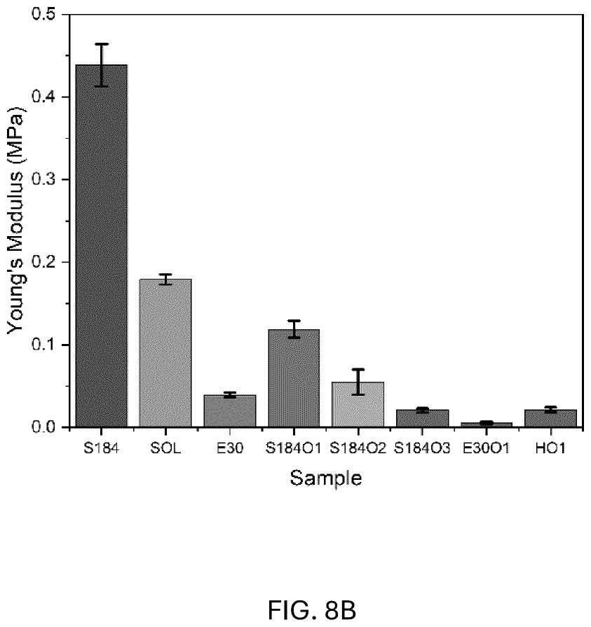

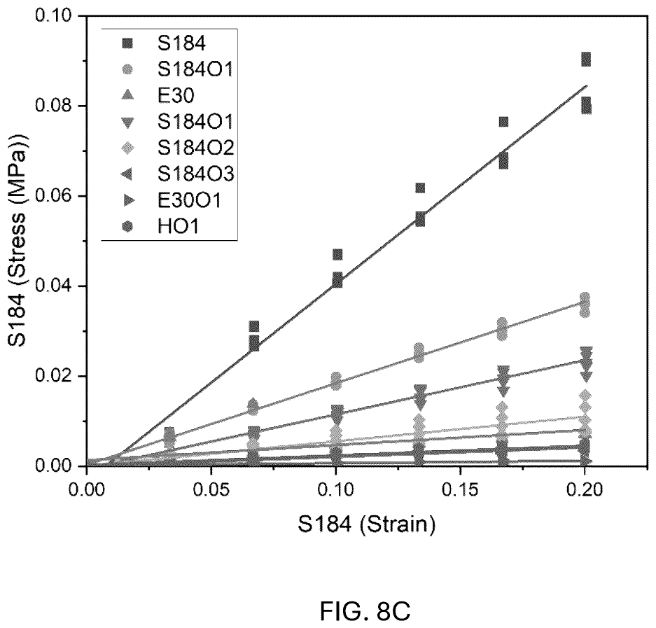

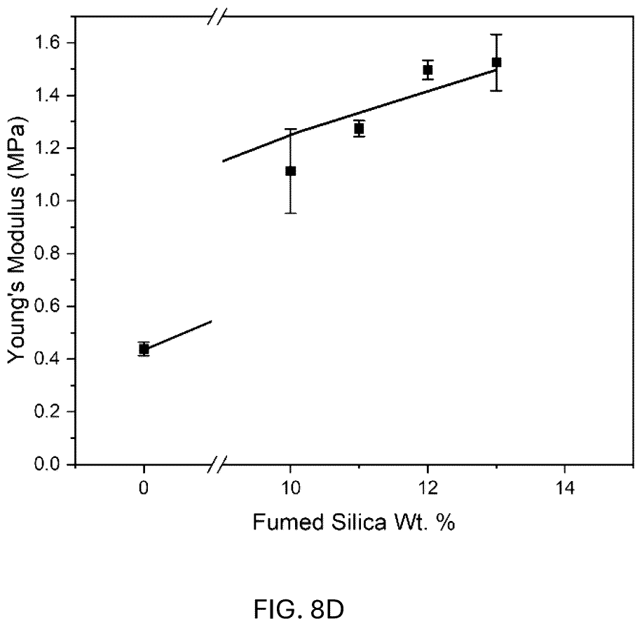

FIG. 8A is a graph showing tensile testing results for the organogel matrixes and silicone. Young's modulus was calculated from a strain range of 20%. FIG. 8B is a graph sowing Young's modulus for the samples, where the organogels have significantly lower Young's modulus values than that of the comparable silicones. FIG. 8C is a graph showing tensile testing results for fumed silica filled dielectric gel. FIG. 8D is a graph showing values of Young's modulus for the fumed silica filled dielectric gel, pure dielectric gel, and S184O1. There appears to be a linear relationship between wt. % fumed silica and Young's modulus.

### Poisson's Ratio

The key feature of an auxetic structure is that it possesses a negative Poisson's ratio. This means when the structure is stretched, instead of deforming inwards, it expands in the opposite direction. The estimated Poisson's ratio for the auxetic structure was calculated using Masters et al equation for re-entrant structures. It was found that the estimated Poisson's ratio for the sample was −1.22. It should be noted that Poisson's ratio in this case is defined in 2D, as the re-entrant structure used is for two dimensions not 3d. In addition, the focus in this experiment is the change in area on the surface of the organogel composite, not including the thickness of the sample. Values for Poisson's ratio of the organogel composite were compared to the base silicone and organogels with no auxetic structures.

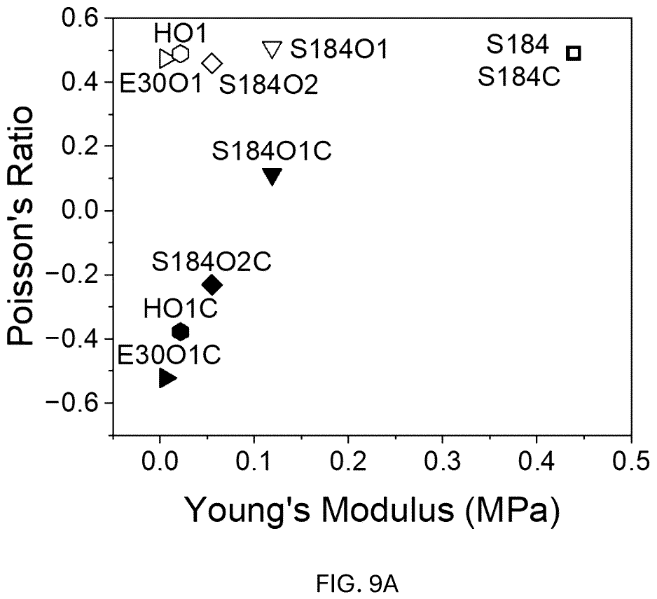

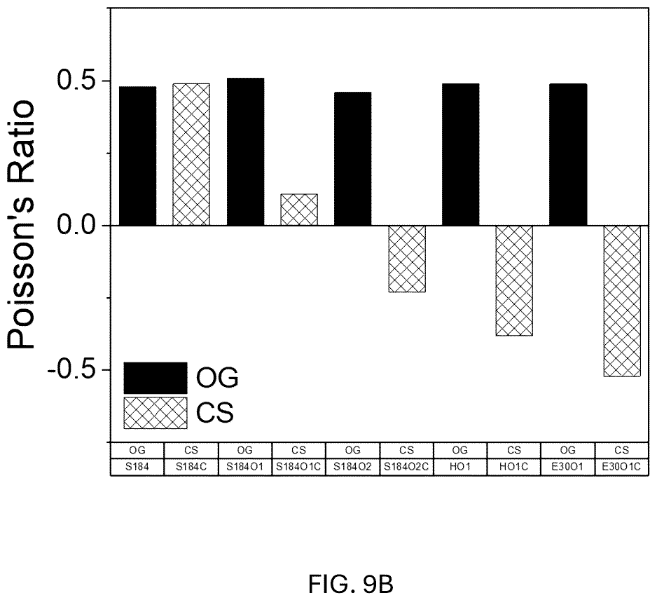

The Poisson's ratio for the unstructured samples reached values around 0.5, which was expected for incompressible rubber like materials. The addition of the auxetic structure to the composite had a notable effect on most matrix materials, with dielectric gel being the only sample with little to no effect. The addition of the auxetic structure significantly lowered the Poisson's ratio for the remaining samples, with S184O2, HO1 and E30O1 showing negative Poisson's ratio, indicating that they were auxetic. When plotting the Poisson's ratio against the elastic modulus, there was a clear trend that softer materials would have a lower Poisson's ratio. Decreasing elastic modulus correlated to a decrease in the Poisson's ratio, with E30O1 having both the lowest elastic modulus and Poisson's ratio. Therefore, to minimize the Poisson's ratio, one should lower the elastic modulus of the matrix as much as possible. The values obtained for the Poisson's ratio was higher than that of the estimated value. This was expected as the structure was not stretched to its maximum displacement. Other factors that could have impacted this result include the embedded organogel, which would reduce the effectiveness of the auxetic structure, the most likely reason why the Poisson's ratio did not reach its theoretical value. FIGS. 9A and 9B show Poisson's testing results. FIG. 9B is a plot that compares the Poisson's ratio values between plain organogels and organogel composites. There is a noted decrease in Poisson's ratio with the organogel composites. FIG. 9A is a plot that shows the relationship between Poisson's ratio and the elastic modulus of the organogel matrix. With decreasing elastic modulus, Poisson's ratio decreases further.

### Ice Adhesion Results

After mechanical testing of the organogels and the auxetic structure, the effectiveness of the organogels anti-icing capabilities was performed. This was done with two versions of static ice adhesion testing. The first was based on methods done in previous literature with the use of force gauge and linear stage pushing a frozen cuvette. The force required to shear the ice from the substrate was recorded and converted into the critical shear stress by dividing the force by the area.

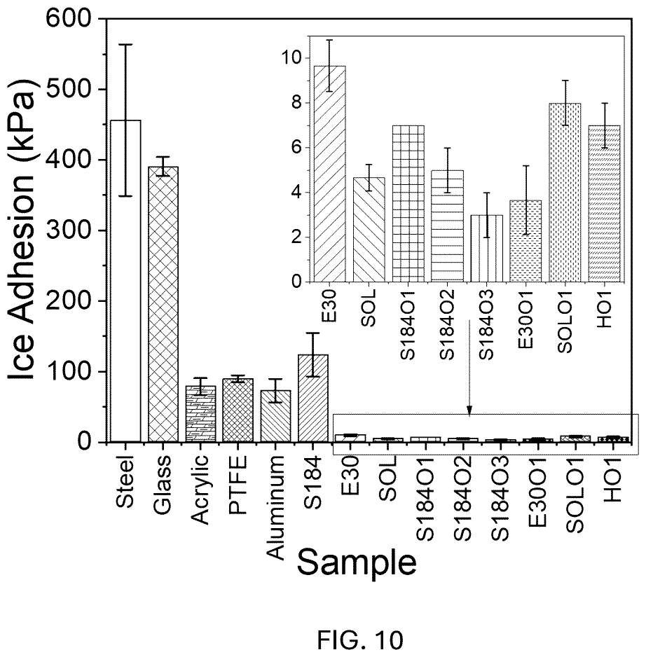

There was a notable difference between control, silicone, and organogel samples. Steel had the largest ice adhesion strength of the tested samples. It should be noted that during the test, steel and glass had the only cohesive failure in the test group. Cohesive failure refers to ice breaking instead of the ice separating from the surface of the substrate which is referred to adhesive failure. There was ice left on the surface of the steel plate after ice adhesion testing was performed. All other tests resulted in adhesive failure. Another notable result was PTFE value as it was previously suggested that hydrophobic materials would have lower ice adhesion strength, however PTFE had a relatively large value when compared to the silicones and organogels. FIG. 10 shows ice adhesion testing values. There is a significant decrease in ice adhesion strength when comparing the standard surfaces and the organogels. Note that all the organogels ice adhesion strength values are under 20 kPa.

The addition of oil appeared to have a significant effect on the anti-icing capabilities of the gels. Almost every sample with oil mixed in had a lower ice adhesion strength when compared to the base counterparts except for Solaris. Dielectric gel had a significant effect, with the addition of more oil lowering the ice adhesion strength. Silicone rubber had a similar effect when mixed with oil. The hybrid sample had an ice adhesion strength comparable to that of the dielectric gel 1:1 oil sample. Solaris was an outlier, as the addition of oil increased the ice adhesion strength instead of decreasing the strength. Solaris was also noted for having a low ice adhesion strength when compared to dielectric gel and Silicone rubber, showing that there are potentially other factors on why its ice adhesion strength was so low.

The baseline goal ice adhesion value was around or below 20 kPa. Previous papers have discussed how this is the barrier for passive ice adhesion in a system, where wind, vibrations, and other natural forces can passively shear the ice from a surface (source). All of the silicones and organogels met these criteria except for Sylgard 184 which had a much higher ice adhesion value, indicating that they had anti-fouling properties. Another static ice adhesion test was devised to try and quantify the stretching test effectiveness as the impact ice adhesion needed some more optimization to be consistent. In addition, this was also done to determine the effectiveness of the auxetic structure when incorporated into an organogel to form a composite. Samples were tested with and without the auxetic structure and repeated 3 times in total. The 3 base silicones were tested and found that stretching had no effect removing the cuvette from the surface of the gel. After 50 cycles, the cuvette remained on the surface of the silicones, indicating that the stretching shear was not enough to dislodge the ice on the surface. In addition, it was found that Solaris would be a poor choice for the gel as it was the only base silicone that fractured during testing, possibly due to it being more brittle at colder temperatures despite its advertised −100° C. working conditions It should be also noted that the Solaris broke where it was gripped, as the abrasive tape could have possible functioned as a crack initiator for the Solaris. Four different organogel samples were tested as well, the HO1, S184O1-3 organogel samples. When tested, it was found that the S184O2 sample fractured near the grips when tested multiple times. This was unusual as the S184O1 and S184O3 organogels did not fracture during their testing cycles. Similar to the Solaris, it could be that the abrasive tape used to grip the samples could have served as a crack initiation point. The reason that the S184O2 broke and the S184O1 and S184O3 did not could be due to their difference in material properties as the S184O1 might be stiff enough to the point where the tape cannot weaken the organogel and the S184O3 might be soft enough to deform around the tape at the lower temperatures that where tested. In general, the use of silicone oil mixed in appeared to have no effect on the anti-icing performance when compared to the base silicone rubbers with no auxetic structure present. This was surprising due to the notable decrease in ice adhesion strength when the oil was added to the silicone gels. The auxetic structures appeared to have a significant effect on the anti-icing capabilities. This occurred with all 3 silicones with the auxetic structure added. In addition, the auxetic structure embedded in the S184O2C sample did not fracture, indicating that the auxetic also acts as a reinforcement and helps prevent fracturing of the structure as the gel would have some cracks in the outside extremes of the samples but would be fine within the unit cells of the embedded structure.

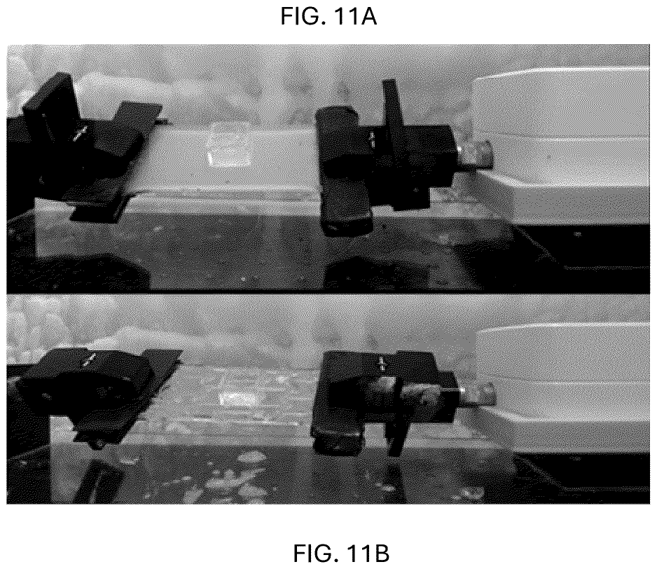

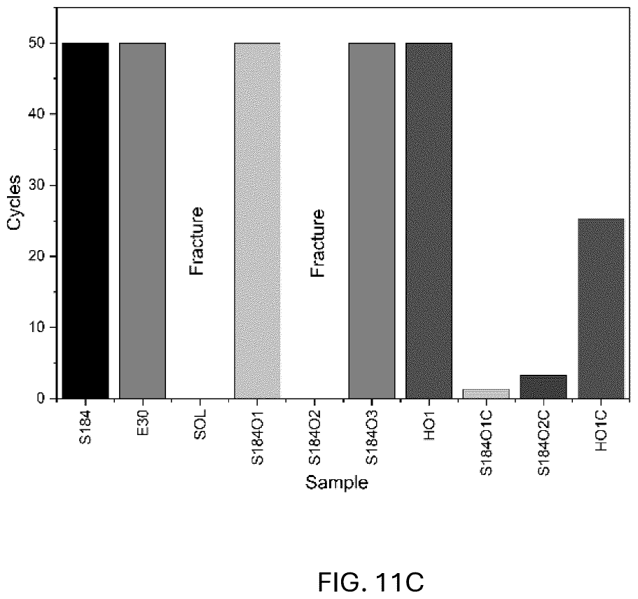

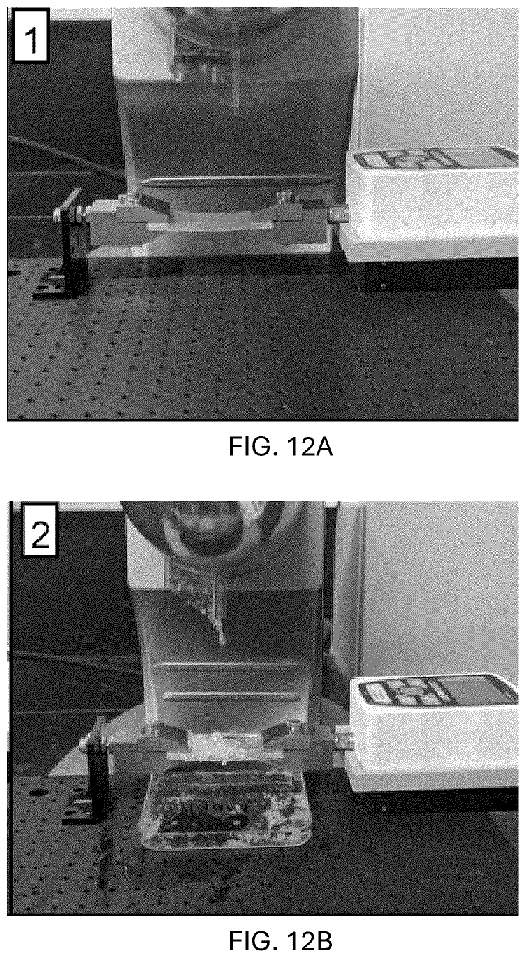

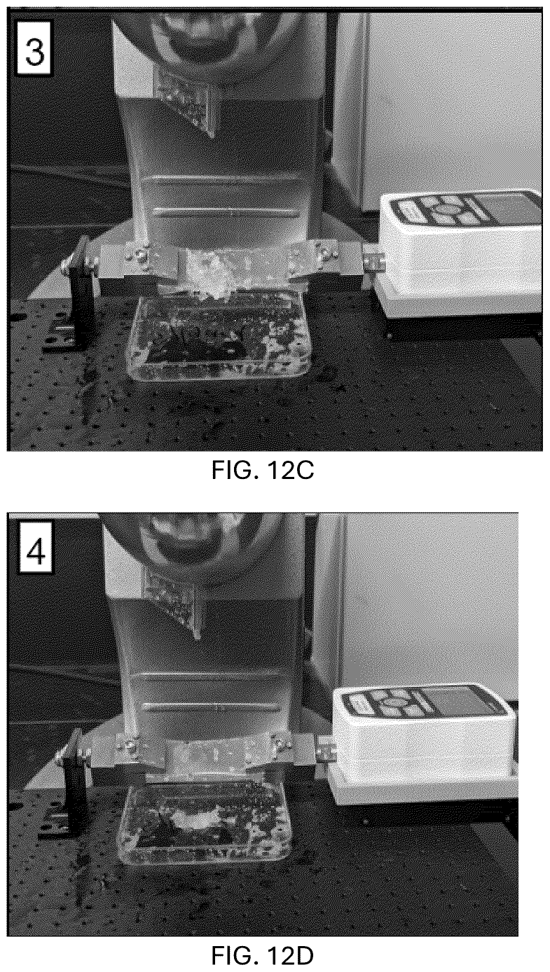

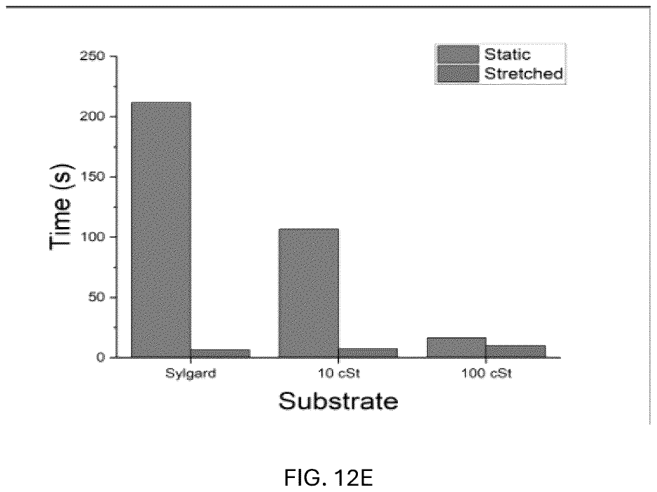

FIG. 11A shows the stretching test of the dielectric gel Sample. The sample appears translucent due to the fabrication with a PTFE mold what leaves small striations on the surface of the sample, causing it to look translucent. FIG. 11B shows the stretching test of the S184O2 Auxetic Sample. The texture that appears on this sample is the auxetic structure embedded within the organogel. FIG. 11C shows results of the cyclic ice adhesion testing after applying fifty strain cycles for each test. A result of fifty means that the sample did not shed any ice after 50 strain cycles which occurred to most of the neat silicones. The Solaris and S184O2 samples fractured almost immediately during the first applied strain cycle, making it impossible to obtain any data. Values lower than fifty are the amount of strain cycles required for the ice to be shed from the surface. FIGS. 12A-12D show the stretching test of various samples with ice slush placed thereon. The results of this testing shown in FIG. 12E show that slush on the samples would fall off after a few stretching cycles, typically within 10 seconds. There is a large decrease in time for ice to slide off when stretched.

### CONCLUSION

The present disclosure provides a novel stretchable organogel composite shield to protect camera and autonomous vehicle sensors from ice and inclement weather conditions. When stretched, the organogel composite would shed the ice that formed on the surface due to the outward stretching of the auxetic skeleton. In order to accomplish this task, a slippery organogel was created as the base of the anti-fouling surface and media. Various different silicone rubbers were evaluated and mixed with silicone oil with different mixing ratios were tested as candidates. S184O2 appeared to be the best candidate due to its transparency and low ice adhesion. Next, the auxetic structure was developed for the organogel. This was done by mixing fumed silica with dielectric gel, with the fumed silica acting as a rheological modifier. Tensile testing was performed to observe the difference in Young's modulus between the silicones, organogels, and the fumed silica mixture. The addition of oil made the organogels significantly softer than silicones, and the addition of fumed silica greatly increased the Young's modulus of the dielectric gel specimens. Poisson's ratio testing was done to ensure that the structure still maintained a negative Poisson's ratio. It was found that the embedded structure's Poisson's ratio decreased with lower Young's modulus, indicating that softer materials should be used for the shield. Finally, ice adhesion testing was designed and performed on the organogels to ensure that the organogels were able to perform at cold temperatures. A static non-impact ice adhesion test was done as a baseline test to compare the ice adhesion across different samples. The slippery organogels had significantly lower critical shear stress when compared to surfaces considered hydrophobic. Another test was performed to attempt to measure the effectiveness of stretching the organogel using a cuvette full of ice. Using a linear stage, water was frozen on the surface of the organogel test and stretched repeatedly until the ice was shed off. It was found that the auxetic structured organogels were able to remove the ice from the surface when stretched when compared to the base organogels which the ice remained on the surface of the gels. In conclusion, a novel stretchable anti-fouling organogel with auxetic properties was developed and tested.

### REFERENCES

[1] Hosseinian S M, Hamid Mirzahossein H and Guzik R 2024 Sustainable Integration of Autonomous Vehicles into Road Networks: Ecological and Passenger Comfort Considerations Sustainability 16 6239
[2] Yeong D J, Velasco-Hernandez G, Barry J and Walsh J 2021 Sensor and Sensor Fusion Technology in Autonomous Vehicles: A Review Sensors 21 2140
[3] Freepik Self Driving Car Concept Illustration https://www.freepik.com/free-vector/self-driving-car-concept-illustration_36242175.htm#query=self%20driving%20car&position=2&from_view-keyword&track=ais_hybrid&uuid=21de0eef-2dba-49d7-be92-e0e83a652336 (Freepik)
[4] Latthe S, Terashima C, Nakata K and Fujishima A 2014 Superhydrophobic Surfaces Developed by Mimicking Hierarchical Surface Morphology of Lotus Leaf Molecules 19 4256-4283
[5] Cassie A B and Baxter S 1944 Wettability of Porous Surfaces Transactions of the Faraday Society 40 546
[6] Chieng B W, Ibrahim N A, Talib Z A and Daud N A 2019 Synthesis, Technology and Applications of Carbon Nanomaterials (Amsterdam: Elsevier) 177-203
[7] Urata C, Nagashima H, Hatton B D and Hozumi A 2021 Transparent Organogel Films showing extremely efficient and durable anti-icing performance ACS Applied Materials & Interfaces 13 28925-28937
[8] Ritter S 2001 What's that Stuff? Chemical & Engineering News Archive 79 30
[9] Yao X, Chen B, Morelle X P and Suo Z 2021 Anti-icing propylene-glycol materials Extreme Mechanics Letters 44 101225
[10] Wong T-S, Kang S H, Tang S K Y, Smythe E J, Hatton B D, Grinthal A and Aizenberg J 2011 Bioinspired Self-repairing Slippery Surfaces with Pressure-stable Omniphobicity Nature 477 443-447
[11] Sahoo S, Kumar N, Bhattacharya C, Sagiri S S, Jain K, Pal K, Ray S S and Nayak B 2011 Organogels: Properties and Applications in Drug Delivery Designed Monomers and Polymers 14 95-108
[12] King D R, Okumura T, Takahashi R, Kurokawa T and Gong J P 2019 Macroscale Double Networks: Design Criteria for Optimizing Strength and Toughness ACS Applied Materials & Interfaces 11 35343-35353
[13] Cui W, Huang Y, Chen L, Zheng Y, Saruwatari Y, Hui C-Y, Kurokawa T, King D R and Gong J P 2021 Tiny yet Tough: Maximizing the Toughness of Fiber-reinforced Soft Composites in the Absence of a Fiber-fracture Mechanism Matter 4 3646-3661
[14] Cui W, King D R, Huang Y, Chen L, Sun T L, Guo Y, Saruwatari Y, Hui C Y, Kurokawa T and Gong J P 2020 Fiber-Reinforced Viscoelastomers Show Extraordinary Crack Resistance That Exceeds Metals Advanced Materials 32 1907180
[15] Okumura T, Takahashi R, Hagita K, King D R and Gong J P 2021 Improving the strength and toughness of macroscale double networks by exploiting Poisson's ratio mismatch Scientific Reports 11 13280
[16] Li X, Peng W, Wu W, Xiong J and Lu Y 2023 Auxetic Mechanical Metamaterials: from Soft to Stiff International Journal of Extreme Manufacturing 5 042003
[17] Ren X, Das R, Tran P, Ngo T D and Xie Y M 2018 Auxetic Metamaterials and Structures: A Review Smart Materials and Structures 27 023001
[18] Liu Y, Zhao C, Xu C, Ren J and Zhong J 2023 Auxetic Meta-materials and their Engineering Applications: A Review Engineering Research Express 5 042003
[19] Cho H, Seo D and Kim D-N 2018 Handbook of Mechanical Materials (Singapore: Springer Singapore) 1-25
[20] Dow Chemicals Sylgard 184 https://www.dow.com/en-us/pdp.sylgard-184-silicone-elastomer-kit.01064291z.html#overview (USA: Dow Chemicals)
[21] Smooth on Solaris https://www.smooth-on.com/product-line/solaris/(USA: Smooth on)
[22] Smooth On Ecoflex 00-30 https://www.smooth-on.com/products/ecoflex-00-30/(USA: Smooth on)
[23] Sigma Aldrich 100 cSt Silicone oil https://www.sigmaaldrich.com/CA/en/product/aldrich/378364?srsltid=AfmBOor8S4HaYG2zK 3sRWQUqxNqf3urlBob1Xjt0W7EOFuf_vJlaERbI (USA: Sigma Aldrich)
[24] Sigma Aldrich Fumed Silica https://www.sigmaaldrich.com/CA/en/product/aldrich/s5130 (USA: Sigma Aldrich)
[25] Allevi Allevi 2 Bioprinter https://www.allevi3d.com/allevi-2/(USA: 3D Systems)
[26] ASTM 2021 Standard Test Methods for Vulcanized Rubber and Thermoplastic Elastomers Tension (USA: ASTM)
[27] Instron Model 5943 https://www.instron.com/en/products/testing-systems/universal-testing-systems/low-force-universal-testing-systems/5900-series (USA: Instron)
[28] Cellscale UniVert Classroom https://www.cellscale.com/products-cellscale-biomaterials-testing/univert-classroom/(Canada: Cellscale)
[29] Hitachi Spectrophotometer U-3900/3900H https://www.hitachi-hightech.com/ca/en/products/analytical-systems/spectrophotometers/uv-vis-nir/u3900.html (Japan: Hitachi)

Patent documents and publications mentioned in the specification are indicative of the levels of those skilled in the art to which the invention pertains. These documents and publications are incorporated herein by reference to the same extent as if each individual document or publication is specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. An anti-fouling shield composite material comprising:
a cured organogel matrix; and
an auxetic skeletal structure;
wherein the composite material has a negative Poisson's ratio that results in an increase in net surface area of the shield to shed ice from a surface of the shield when stretched.

2. The anti-fouling shield composite material of claim 1 wherein the cured organogel matrix comprises a silicone precursor and a silicone oil.

3. The anti-fouling shield composite material of claim 1 wherein the silicone precursor and the silicone oil are present in the organogel matrix prior to curing at a ratio of 1:1 to 1:3.

4. The anti-fouling shield composite material of claim 1 wherein the cured organogel matrix is formed of Silicone rubber.

5. The anti-fouling shield composite material of claim 1 wherein the auxetic skeletal structure is an elastomeric re-entrant honeycomb structure.

6. The anti-fouling shield composite material of claim 1 wherein the auxetic skeletal structure is formed of a second material comprising fumed silica filled silicone precursor.

7. The anti-fouling shield composite material of claim 6 wherein the fumed silica is present in an amount of 0 to 50 wt % of the second material.

8. The anti-fouling shield composite material of claim 1 wherein the composite material expands its width upon extension of the length direction.

9. The anti-fouling shield composite material of claim 1 wherein the organogel matrix is configured to provide a stretchy, anti-icing surface used to shed any ice buildup threreon.

10. The anti-fouling shield composite material of claim 1 wherein the auxetic structure is configured to create an areal mismatch between the organogel matrix and the ice.

11. The anti-fouling shield composite material of claim 1 wherein the anti-ice shield is configured for anti-icing optical sensors for autonomous vehicles, anti-icing airplane wings, and anti-biofouling marine ship hulls.

12. The anti-fouling shield composite material of claim 1 wherein the cured organogel matrix is transparent.

13. The anti-fouling shield composite material of claim 1 wherein the auxetic skeletal structure is translucent.

14. A method of forming an anti-fouling shield composite material, the method comprising:
mixing a silicone and a silicone oil to form an uncured organogel matrix;
separately mixing fumed silica and a silicone precursor to form a second uncured material;
shaping an auxetic skeletal structure using the second uncured material;
curing the second uncured material of the shaped auxetic skeletal structure to form the cured auxetic skeletal structure;
placing the cured auxetic skeletal structure in a mold having a shape of the anti-fouling shield;
pouring the uncured organogel matrix into the mold having the shape of the anti-fouling shield around and covering the cured auxetic skeletal structure; and
curing the uncured organogel matrix to form the anti-fouling shield composite material.

15. The method of claim 14 wherein the silicone and the silicone oil are present in the uncured organogel matrix at a ratio of 1:1 to 1:3.

16. The method of claim 14 wherein shaping the auxetic skeletal structure includes 3D printing or molding the auxetic skeletal structure.

17. The method of claim 14 wherein curing the second uncured material including curing at 80° C. for 30 minutes.

18. The method of claim 14 wherein curing the uncured organogel matrix includes curing in an over at 80° C. for more than one hour.
